(19) United States
(12) Patent Application Publication
(10) Pub. No.: US 2020/0285457 A1
(43) Pub. Date: Sep. 10, 2020

(54) ASSET UPDATE SERVICE

(71) Applicant: ARM IP LIMITED, Cambridge (GB)

(72) Inventors: Milosch MERIAC, Cambridge, Cambridgeshire (GB); Brendan James MORAN, Histon, Cambridgeshire (GB); Robert George TAYLOR, Cambridge, Cambridgeshire (GB); Amyas Edward Wykes PHILLIPS, Cambridge, Cambridgeshire (GB); Daniel ROS, Sawston, Cambridgeshire (GB); John-Paul STANFORD, Cambridge, Cambridgeshire (GB)

(21) Appl. No.: 16/644,720

(22) PCT Filed: Oct. 17, 2018
(86) PCT No.: PCT/GB2018/052996

§ 371 Date: Mar. 5, 2020

(30) Foreign Application Priority Data
Oct. 19, 2017 (GB) 1717204.0

(51) Int. Cl. G06F 8/65; H04L 29/08

(52) U.S. Cl. CPC G06F 8/65; H04L 67/34

(57) ABSTRACT

A method for managing an asset update service for one or more service requesters on a plurality of remote devices, the method comprising: receiving, at a management server, update data indicating an asset to be updated at one or more remote devices; receiving, at the management server, campaign data associated with the update data and indicating a subset of the remote devices to which an update is to be applied; and receiving, at the management server, a request to initiate the firmware update by transmitting to the subset of the remote devices an update communication indicating that the asset is to be retrieved for updating the asset of the remote device.

The present application relates to a mechanism to enable a service to update the firmware or other asset data of networked electronic devices in an automated and reliable manner that can be managed by third parties.

Remote electronic devices may be configured to connect to a server and to communicate with that server. The server many be configured to manage operation and communication with the devices. In many applications, such as internet of things (IoT) applications, there may be many similar or identical devices that are configured to connect to the server and be managed by that server in similar or the same way.

In order for the devices to operate in a secure and reliable manner it is necessary to provide updates to assets of the devices, such as code, keys, and/or configuration of the device. In an example, firmware operating on the device may need to be updated—for example to address security flaws or to modify the behaviour of the device. In many such applications, the devices may be physically disparate or inaccessible or so numerous that it is unfeasible to directly and manually update the firmware of each device separately.

There is therefore a desire to improve the manner by which the assets (such as firmware) of remote electronic devices is updated.

A method for enabling an asset update for one or more service requesters on a plurality of remote devices, the method comprising: receiving, at a management server, update data indicating an asset to be updated at one or more remote devices for a first service requester, the update data comprising manifest data comprising a payload uniform resource identifier (URI) indicating where the payload is stored, authentication information indicating the trust of the manifest data, and a payload hash; receiving, at the management server, campaign data associated with the update data and indicating at least a subset of the remote devices to which an asset update is to be applied for the first service requester; and receiving, at the management server, a request to initiate the asset update for the first service requester by transmitting to the at least the subset of the remote devices indicated by the campaign data an update communication comprising the manifest data indicating that a payload is to be retrieved for updating the remote device.

A management server for enabling an asset update for one or more service requesters on a plurality of remote devices, the management server comprising: at least one interface to: receive, at the management server, update data indicating an asset to be updated at one or more remote devices for a first service requester, the update data comprising manifest data comprising a payload uniform resource identifier (URI) indicating where the payload is stored, authentication information indicating the trust of the manifest data, and a payload hash; receive, at the management server, campaign data associated with the update data and indicating at least a subset of the remote devices to which an update is to be applied for the first service requester; and receive, at the management server, a request to initiate the asset update for the first service requester by transmitting to the at least the subset of the remote devices indicated by the campaign data an update communication comprising the manifest data indicating that a payload is to be retrieved for updating the remote device.

Examples of the disclosure will be described with reference to the appended drawings in which:

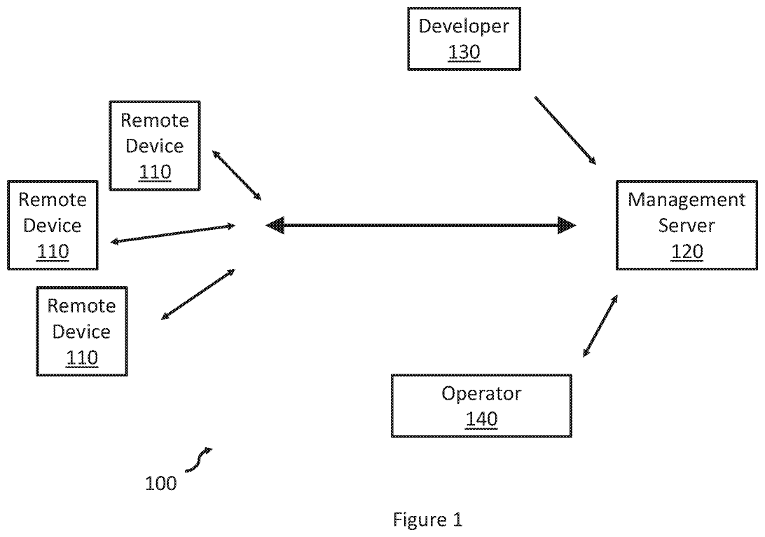

FIG. 1 illustrates a system diagram according to an example;

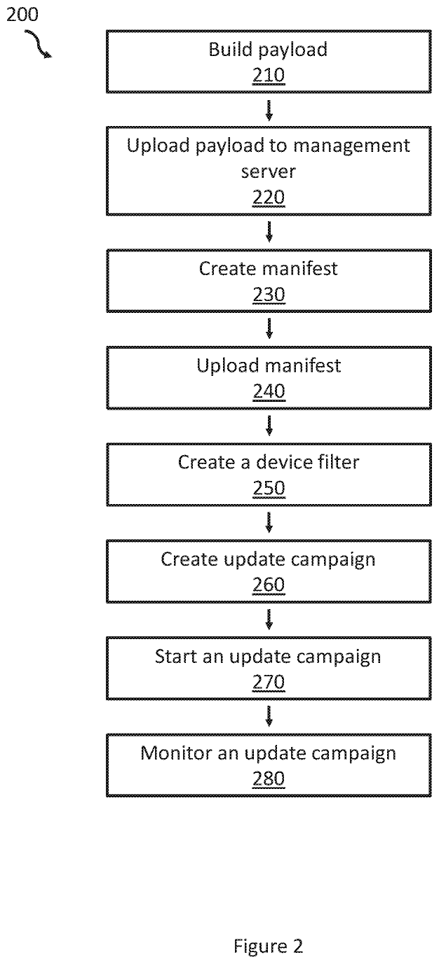

FIG. 2 illustrates a flow chart of an example method for initiating an update of firmware according to a campaign;

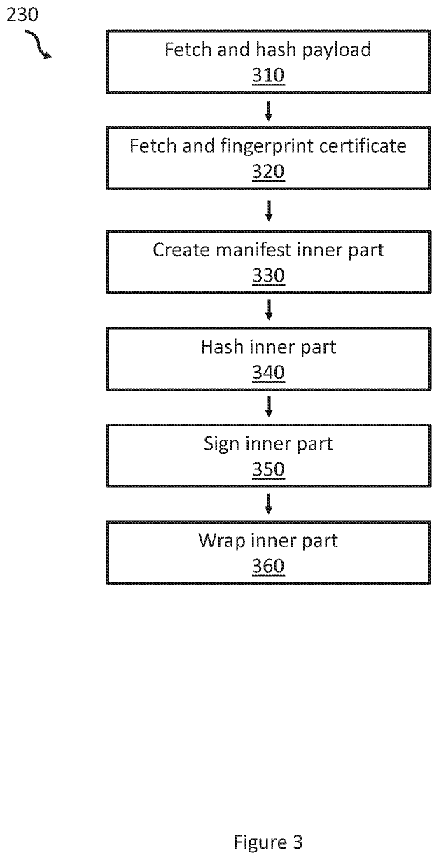

FIG. 3 illustrates a flow chart of an example method for creating a manifest;

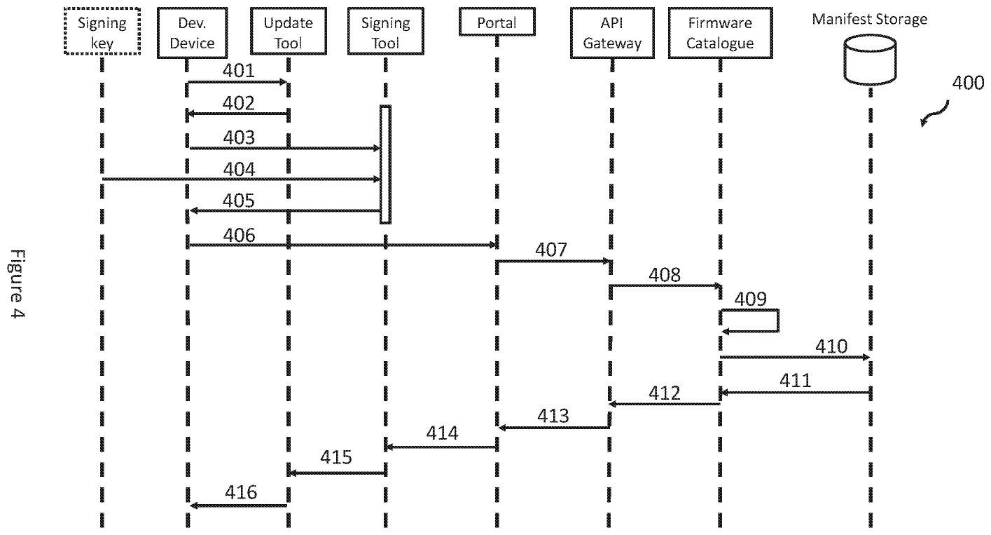

FIG. 4 illustrates an example workflow for uploading a manifest to the management server;

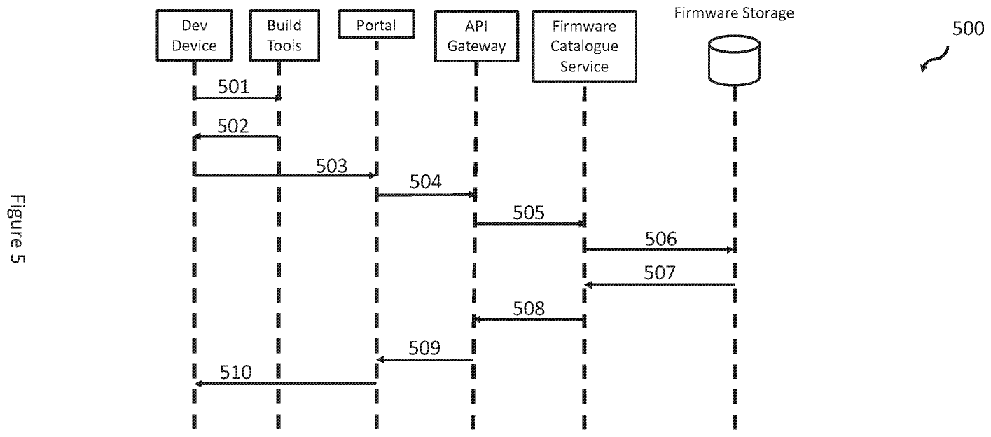

FIG. 5 illustrates an example workflow for uploading a payload to the management server;

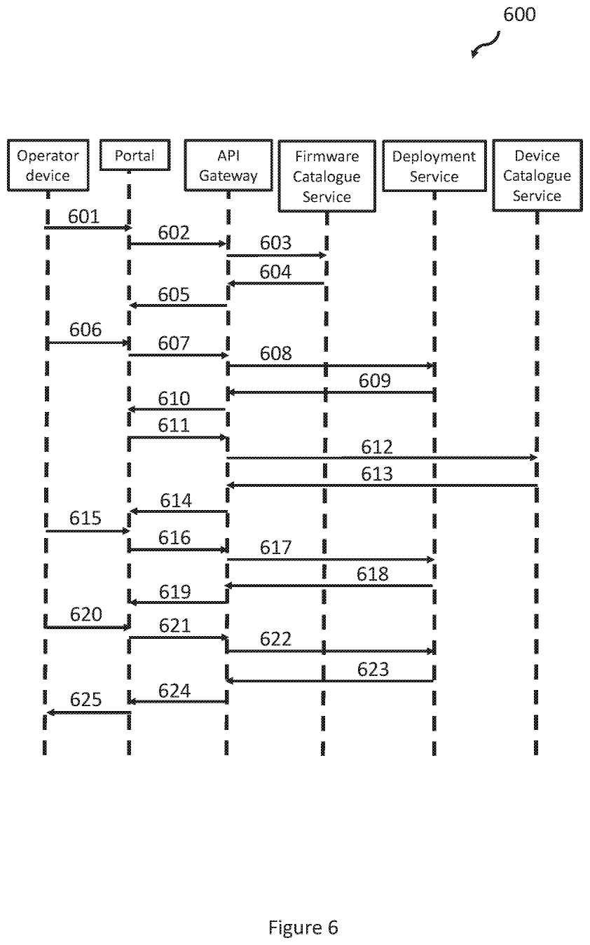

FIG. 6 illustrates an example workflow for creating a campaign;

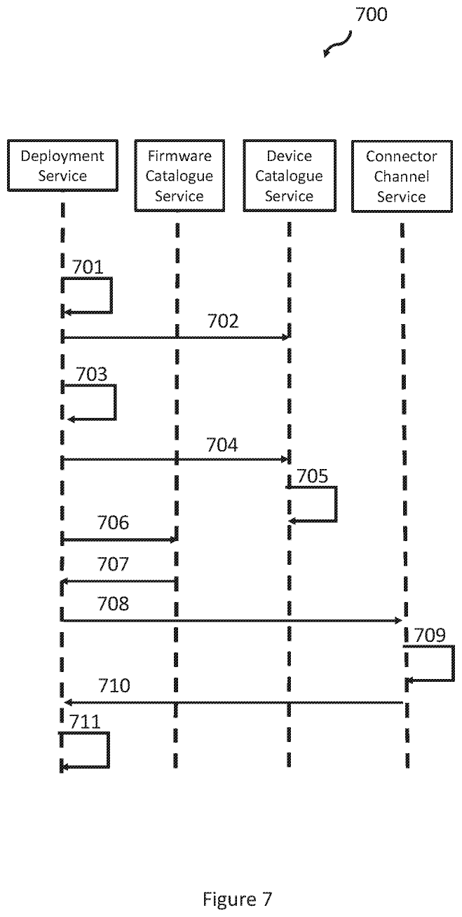

FIG. 7 illustrates an example workflow for processing a campaign;

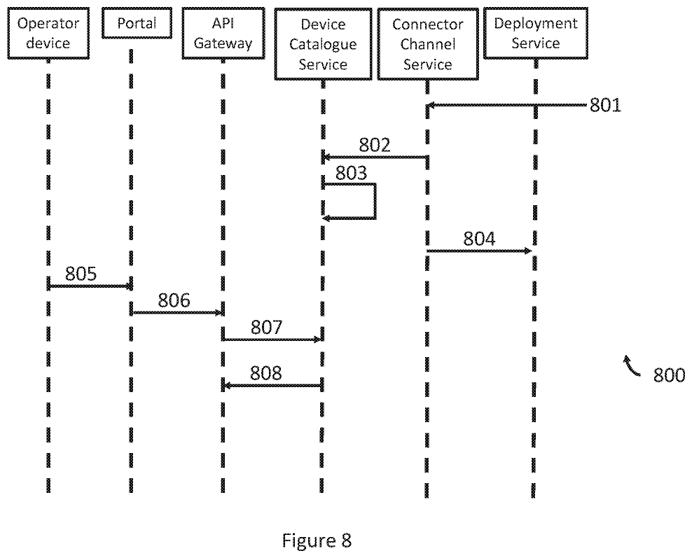

FIG. 8 illustrates an example workflow for monitoring the progress of a campaign; and

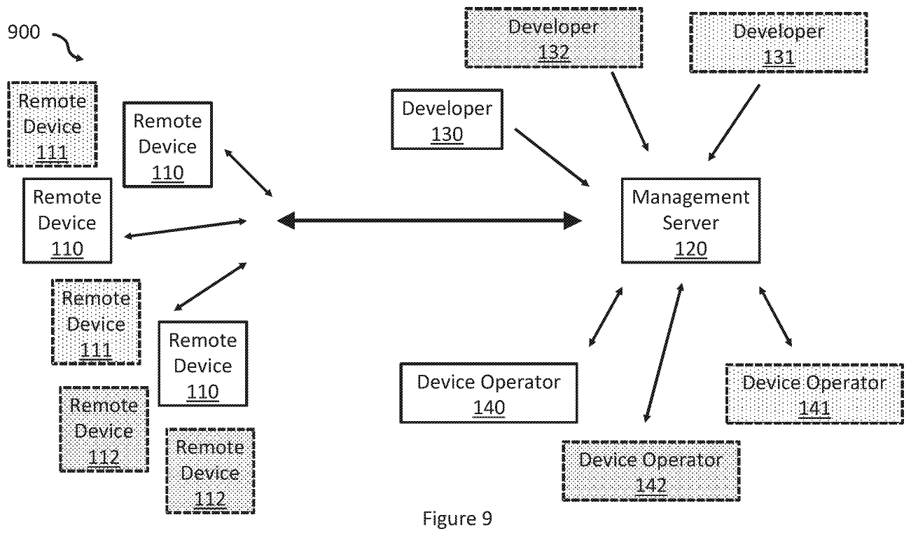

FIG. 9 illustrates a further system diagram according to a further example comprising multiple service requesters.

The present application relates to the provision of apparatuses and methods by which the updating of assets of one or more remote devices can be enabled in an automated and reliable manner. The updating of assets provides third parties with the capability to delegate the responsibility for enacting an update campaign to an update service which has a number of technical benefits. One aspect of the delegation is that third parties may not want to have to trust the update service to roll out an update.

The update service provides how to enable a service to perform an update on behalf of a third party without the third party having to place trust in the service, based on an established trust relationship between the third party and the device. In addition, the update service does not necessarily need to have direct access to the payload and does not deliver that payload directly to the devices.

Therefore, in embodiments the owner of the firmware update and the device managing entity (i.e. the first service requester) need not be the same entity.

By the third party providing to the service manifest data comprising a payload URI, authentication information indicating the trust of the manifest data, and payload hash for transmission to the remote device, the remote device is equipped with everything it needs to perform an asset update in a trusted manner because the remote device already has an established level of trust with the third party. As such, the manifest information can be distributed to the service and provided to a number of remote devices without requiring the trust of the service. This is because the remote device can trust the manifest data (due to the authentication information) and thus can trust the payload URI, based on a trust relationship between first service requestor and remote device. Since the payload URI is trusted, the remote device can be sure that the URI from which the asset is retrieved is valid. Furthermore, since the payload hash is also trusted, the device can perform authentication of the retrieved hash and thus can have trust in the obtained payload.

In addition, the “first service requester” does not need to be potentially involved and complex technical capability to connect to a number of different remote devices, which could involve multiple different communication protocols and devices with different processing capabilities. As such the first service requester is not required to have any capability to communicate directly with the device. This approach enables the separation of responsibility between device owner and device communication enabler in a manner that removes the need for the device owner to trust the device communication enabler.

The following description sets forth a number of examples by way of illustration only.

FIG. 1 illustrates a computing system 100 in which the present techniques may be implemented.

The computing system 100 comprises a plurality of remote electronic devices 110 that are communicatively coupled to a management server 120. The remote electronic devices 110 are electronic devices that may be disparately located, such as Internet-of-Things (IoT) devices. The remote electronic devices 110 may be connected to the management server 120 through different networks or through the same network. For example, the remote electronic devices 110 may be connected via a wired or wireless connection to the management server 120.

The management server 120 is a computing server (or servers) configured to manage the remote devices and their respective connections to the management server 120. The management server enables assets of the devices to be managed and maintained by an owner or manager of the devices. The owner or manager of the devices may require one or more assets of the devices it is responsible for to be updated and thus becomes a requestor that requests of the management server 120 an update of the remote devices 110 associated with that request. The management server 120 may provide one or more interfaces through which the updating of the remote devices can be managed. This may be provided through an interface that receives data provided via a portal and/or receives data via an application programming interface (API) gateway such as a REST API.

In the arrangement of FIG. 1, the management server 120 may be configured to provide new assets, such as new firmware, to the remote devices 110 so that the new assets can be loaded into the remote devices 110 in order to update the device. Assets of the remote devices may include one or more of code (such as firmware or a bootloader), key provisioning or distribution, or configuration settings. In the example of update firmware, there may be a number of reasons why new firmware needs to be loaded into remote devices 110. For example, the firmware may fix critical firmware bugs on the remote device or add new functionality to the device. The management server 120 may comprise software, referred to herein as a cloud update service, that is configured to control the management of the update of the remote devices 110. As described later, the management server 120 operates to ensure that the update process is secure. Security may be provided by determining that the firmware is authenticated (for example, so that attempts to flash a malicious firmware are prevented), or that the firmware can be encrypted. The management server 120 may be configured so that the update is pushed to the remote device 110 from the management server 120, so that the remote device 110 does not have to poll for updates continuously, which this makes the device more energy efficient.

System 100 further comprises a developer device 130 communicatively coupled to the management server 120, for example through the portal and the API. The developer device 130 is an electronic device from which the firmware and its corresponding metadata is provided to the management server 120. This process will be described in more detail later. The developer device may form part of a service requester that requests that the management server 120 provide as a service an update of assets of the device. The developer device may be a device through which a developer is able to provide the firmware image (or other asset data) that is to be applied to the remote devices 110.

System 100 further comprises an operator device 140 communicatively coupled to the management server 120. The operator device is an electronic device from which the management of the remote devices can be handled by the owner of the devices. The operator device 140 therefore forms a part of the service requester that requests an update of assets of the remote devices. The developer that operates the developer device 130 may be the same entity that operates the operator device 140 or the entities may be separate entities.

Updates of assets, such as a firmware update, on the remote devices 100 are provided as a service by the management server and are initiated as a result of the communication of update data from the developer device 130 and campaign data from the operator device 140. In order to update the remote devices 100, each of these two entities provides a respective set of data that collectively defines the update process to be managed by the management server 120 on behalf of the service requester. The developer device 130 is a device that can be operated by or managed by a developer of the updated asset, such as updated firmware data. This allows the location of the developer that develops the firmware to be separate from the location of the management server 120.

Update data may be provided by the developer device 130. The update data provides an indication as to the asset that is to be updated on the remote devices 110 and the manner by which the update of that asset is to occur. For example, the update data may comprise the new value of the asset that is to be updated and the criteria to be met at the remote device in order for the remote device to take the new value. In some example, the update data may comprise payload data and manifest data.

The payload data defines the values of the updated asset to be applied to the remote devices. For example, where the asset to be updated is the firmware of the device, the payload data may define the firmware image data that is to be installed on one or more remote devices 110. The payload data may define the updated firmware and may be a firmware image. The manifest data describes metadata relating to the payload, such as how it is to be updated at the local device, or where it is stored. More detail concerning the type of information that can be stored as manifest data will be described later. As an example, the manifest data may define where to find the payload (e.g. the URI of the payload), the device types to which the payload data applies, and how to decide whether to trust the payload data when it is being applied. The manifest data may be generated at the developer device 130 by a manifest tool operating at the developer device 130. The management server 120 is configured to receive the update data from the developer 130 and, in some examples, to send the manifest data to a remote device 110 to forward the developer's instructions about where to obtain the image and under what conditions to download and apply it. The terms manifest data and payload data are used herein to refer to the data itself, such as a firmware image or the complete manifest data. However, it will be appreciated that reference herein to transmitting manifest data and/or payload data may instead involve transmitting a URI indicating a location at which the receiving entity can separately access the data.

The operator device 140 may provide to the management server 120 campaign data that is associated with a particular set of update data. The operator device 140 is a device that can be operated by or managed by an owner of the devices or an entity responsible for the management of the devices—such as an entity that determines which devices are to be updated and in which manner. An update campaign can be considered to be a strategy by which the remote devices 110 are to be updated and is defined by campaign data. The campaign data for a particular update campaign is configured to couple the manifest with a device filter. The device filter indicates which of the remote devices 110 that are communicatively coupled to the management server 120 should be updated. In this way, the device filter identifies a filter that is to be applied to all remote devices communicatively coupled to the management server 120 so as to select a subset of the remote device 110 to which the update is to be applied. As such, the management server 120 can be configured to use the campaign data of the update campaign to send the manifest to all devices matching the device filter. In some implementations, a manifest may be included in more than one update campaign, coupling it with different filters. This can allow the operator device 140 to manage the update of remote devices 110 in batches, with each update campaign targeting only a subset of the remote devices according to the device filter associated with the batch.

### Manifest Format

As mentioned above, the payload data for an asset to be updated (e.g. a firmware image) is separate from the manifest (e.g. metadata) that describes to a manner by which the update is to occur. By separating the payload from the manifest, the distribution of payload is simplified. For example, a single payload (e.g. firmware image) can be sent to disparate devices. This also permits distribution of the firmware image over a Content Distribution Network, which does not need to be trusted, because trust is established via the metadata—as will be explained later.

In order for a remote device to apply an update of a particular asset, it has to determine that the update it has received should be trusted and should be applied. For example, the device may need to know whether the author of the update can be trusted, whether or not the update is corrupted, whether the update applies to the device, whether the update is up-to-date, at what time the update should be applied.

Accordingly, the manifest may be derived from one or more fields to enable the device to determine whether or not to apply the update. The fields of the manifest form the manifest data provided to the management server 120. A number of fields may be used to generate an encoding that forms the manifest. The fields from which the manifest is derived may comprise one or more of:
a private key that will sign the manifest and its matching certificate;
data indicating the type of signing and encryption used;
timestamp at which the manifest was generated;
manufacturer ID identifying the developer of the firmware and/or the manufacturer of the remote device;
device class ID identifying the class of devices to which the update applies;
payload, for example in the form of a file and/or a link to the payload (for example as a URL);
payload type;
URL from which the remote device 110 should fetch the payload;
storage identifier to indicate where the device should store the payload;
installation condition data indicating conditions under which the payload should be installed, such as based on load on the device;
installation time data indicating a time window during which installation of the payload should occur, for example by defining an earliest and a latest time; and
authentication information indicating the trust of the manifest, for example including a hash of the firmware image and a signature of a trusted developer.

By providing the manifest to the remote device 110, the remote device 110 can determine whether or not to install the received update. As part of this process, the remote device 110 acts to determine whether or not the update is a valid update received from the management server 120.

The system of FIG. 1 may implement security features to ensure that a malicious third party is unable to communicate with the remote devices 110 to force the remote devices 110 to install an unauthorised asset, such as unauthorised firmware containing a security flaw.

### Verification of Data

To secure the manifest, the management server 120 and the developer device 130 are configured to use a cryptographic method, such as public key cryptography.

In an example, each remote device 110 and the developer device 130 are configured to make use of elliptic curve cryptography (ECC), a type of public key cryptography (other public key cryptography techniques may instead be used). In an example, a manifest tool operating at the developer device 130 and the remote device 110 use the Elliptic Curve Digital Signature Algorithm. This algorithm uses two pieces of information: namely a secret, called the private key and a number, called the public key, which corresponds to the secret.

To sign the manifest, the holder of the private key (developer device 130) first computes a hash of the manifest using SHA256, then transforms that hash using the private key. This new number, called the signature, is appended to the manifest. Later, anyone with the public key (such as each remote device 110) can verify that the signature matches the document by: computing a hash of the document using SHA256, transforming the signature back into a hash using the public key, and comparing the computed hash and the signature hash.

If the hashes are the same, then the verifier can be confident that the signer was in possession of the private key. This is because it is a computationally hard problem to determine a private key from a public key, even if you have many examples of a transformation done using the private key.

Public keys are generally packaged inside a certificate, which contains additional information about the public keys and who they belong to. This certificate is also signed, either by another authority (a Certificate Authority) or by itself (a self-signed certificate). Certificates are generally identified by a fingerprint, such as a hash of the certificate (e.g. a SHA256 hash of the certificate).

The remote device may use the ECC curve ecc-secp256r1, a NIST-recommended curve. ECC may be used instead of RSA on the remote devices because of reduced key size and higher performance on computationally limited platforms.

Authenticity is critical to any operation that can modify the behaviour of a device, particularly a firmware update. Validating the authenticity of firmware updates helps keep internet-exposed devices (such as remote devices 110) doing what their designers intend; failure to validate could lead to compromise or destruction of devices.

A signature provides both integrity and authenticity validation to the firmware. Regardless of authority, if the provided signature matches the firmware, then a remote device 110 can be confident that the holder of the private keys for the signature has approved the firmware. This prevents impersonating someone when sending firmware to a device, or modifying the firmware in transit.

Devices can decide which private keys to trust without knowing the private keys, by trusting the matching certificates. Provided that private keys are adequately protected, this guarantees that the device will install only authentic firmware.

The manifest is signed by a private key at the developer device 130, creating a signature. The remote device 110 verifies a manifest's signature using the verification certificate. The manifest will only have a valid signature if it was created with the same private key as the verification certificate, implying whoever created it has access to that key. If the signatures match, the manifest is granted authority. The remote device will reject an incorrectly signed manifest.

The manifest may also contain a hash (such as a SHA256 hash) of the payload (e.g. the firmware image). Since the manifest is signed, this ensures that, regardless of the download method, the manifest can only be used to install a full and unaltered copy of the intended image.

### Update Campaign Management

As mentioned above, the operator device 140 may be configured to transmit to the management server campaign data for an update campaign comprising a device filter that indicates which of the remote devices 110 are to be affected by the update of the asset. Then, when the update campaign is uploaded to the management server 120, the campaign can be started and monitored.

An example process for initiating an update campaign is described in relation to FIG. 2. The process 200 of FIG. 2 begins at step 210 where a developer generates a payload, for example in the form of a firmware image. This step may occur at developer device 130 or may occur at a separate device, from which the payload data is passed to the developer device 130. In some arrangements, only the firmware is built at this step and the bootloader is unchanged. In some arrangements, the memory layout of the original application may be maintained in the new application.

At step 220, the payload data (e.g. the firmware image) is transmitted from the developer device 130 to the management server 120 and is stored either at the management server or at another remote device (not shown in FIG. 1). In some arrangements, the payload data may be stored at a user resource locator (URL) as defined by the developer device 130 (for example in one or more manifests) so that the remote devices can access the payload from a known location. In some arrangements, the management server 120 may allow the upload to the management server to be performed by an API (application programming interface), as described earlier. In some arrangements, the management server may allow the payload to be uploaded via a portal and through the API gateway. In such arrangements, the management server 120 may return to the developer device 130 a URL indicating the stored location of the payload. This returned URL can then be used in the manifest. In some arrangements, the payload may be encrypted.

At step 230, manifest data is generated that defines the manner in which the update of the asset (e.g. firmware) of remote devices 110 should be handled. The manifest may be generated at the developer device 130 and/or may be generated externally and passed to the developer device 130 for transmission to the management server 120. The manifest may be generated at a manifest tool running on the developer device 130 (or other device). As mentioned previously, the manifest may comprise one or more fields that define the manner by which the update of the remote devices should occur, as discussed above. In addition, the manifest may comprise a manifest signature—for example that was generated using a public key cryptographic technique. The manifest may also comprise a hash of the payload that was created and transmitted at steps 210 and 220.

At step 240, the manifest may be transmitted from the developer device 130 to the management server 120. It will be appreciated that the generation and transmission of the manifest and the payload may occur together. Put another way, steps 210 and 230 may be combined and steps 220 and 240 may be combined.

The manifest may be generated in one of a number of ways using a manifest tool. For example, the manifest tool may parse an input file (such as a JSON input file) which comprises information used to create the manifest. Where information is missing from the input file, the manifest tool may check for a defaults file that contains default values for fields missing in the input file. Alternatively, the manifest tool may generate a manifest by receiving command line arguments defining the fields to be inserted into the generated manifest.

In some arrangements, the manifest with an unencrypted payload may comprise at least (i) a cryptographic mode to use (such as none-ecc-secp256r1-sha256), (ii) a payload URI (uniform resource identifier), (iii) one of a URI of a certificate to be used for signing the manifest or a local file that is to be used for signing the manifest, (iv) a local file that is the signing key for that certificate, and (v) one of a vendor ID and device class ID, or a device ID (to identify devices to which the manifest applies).

In this mode, the manifest tool creates a manifest that is signed; the payload is unencrypted. The target remote device(s) 110 already has the provided certificate, or provides a way to fetch that certificate. An example approach for creating a manifest will be described later.

At step 240, the generated manifest can be uploaded to the management server in a similar manner to the payload of step 220, for example via an API and/or via a portal.

At step 250, a device filter is created at the operator device 140. The device filter indicates a plurality of remote devices 110 which are to be updated. When processed the device filter prevents remote devices 110 which are not permitted to be updated from being updated. The format of the device filter will be described in more detail.

At step 260, an update campaign is created at the operator device 140 by defining campaign data for the update campaign. As mentioned previously, an update campaign defines an approach for updating the assets of remote devices and can be considered as a construct by which assets such as firmware updates are presented to one or more pre-determined remote devices. Typically, a campaign may comprise or be associated with at least one manifest as defined from a developer device 130 and a device filter as defined at the operator device 140. Accordingly, the update campaign collectively defines an asset update that is to be applied, the manner in which it is to be applied, and the devices to which the asset update is to be applied in the defined manner.

Accordingly, campaign data can be considered to be a definition of a process that advertises a manifest to one or more devices. This can be done by writing to a manifest resource on the appropriate remote device 110 via a connection service hosted on the management server 120. If a particular remote device is not reachable immediately, it is possible for it to miss the advertisement and hence miss the update. This can be mitigated by starting a second, different campaign to those devices using the same or a different device filter. Devices which have already been updated will ignore the second campaign, either because it is not listed in the device filter or because it already has the latest firmware version. The list of devices to which the asset update is to be applied may be derived from a device directory, which may be a global register of registered devices. The mechanism to select a subset of devices is a device filter. Although the manifest may pre-set a filter with a class and/or a vendor of the devices it is compatible with, deployments may require additional device targeting information.

For example, instead of or in addition to a class or vendor ID it may be possible to filter the devices that are advertised to according to a campaign using other fields. For example, there may be fields that indicate a physical location of the devices, a model number of the devices, or other such fields. An example filter is illustrated below which will advertise the update to a number of devices with a particular model number within a particular floor of a particular building:

mode1=‘AIRCONv3-revB’, customer=‘ARM’, city=‘CAMBRIDGE’, building=‘CPC1’, floor=‘2’

In some examples, the operator device 140 may access an API to connect to the management server 120 which may allow the following actions to take place to manage campaigns and device filters:
view a list of all currently connected remote devices;
create and save filters to make the list more navigable;
view and edit device details;
add custom attributes to a device;
view connected devices' resource values;
create, manage and use device filters;
add custom attributes;
access the device event log;
delete devices; and
revoke and generate new certificates or keys.

To explain the generation of remote device filters, it is also useful to provide some detail on the lifecycle of a remote device. During manufacture of a remote device, the device can be provided with: a device certificate, which provides access credentials to the management server; and application code, along with a bootloader.

The status of a device changes as the device goes through the bootstrap process to enrol it on with a management service provided by the management server. Once fabricated, a remote device starts in an “unenrolled” status. Once enrolment is complete, the remote device enters a “registered” state. In the event of an error during an enrolment process, the device will not make it to the registered state. The device status can be accessed via the management server.

The management server may be configured using one or more of the following fields:
device ID identifying the device;
device name;
device description;
state;
date created: the date and time the remote device was available for update;
date bootstrapped: the date and time the remote device was bootstrapped;
serial number, which is read only and may be populated from the device's firmware;
vendor ID: The remote device's vendor ID, which is read only and may be populated from the device's firmware;
remote device class: the type ID of the remote device, which is read only and may be populated from the device's firmware;
factory name; and
location based attributes, such as building and floor numbers.

Where state can take one of the following values:
unenrolled: initial state when a device is added to the management server;
cloud enrolling: the remote device has been added to parts of the service and has started bootstrapping;
bootstrapped: the remote device now has bootstrapped and has an identity with the management service provided by the management server, but has not yet available for update;
registered: the remote device is registered and available for update; and
deregistered: the remote device is no longer registered, either due to deregistration or expired registration.

Managing devices in a large-scale cloud deployment can be overwhelming due to the large number of devices in the field. Complex and sophisticated filters that enable the selection and management of devices can be provided by maintaining a list of fields. The fields can then be used to generate such complex filters, which can be used to interact with or monitor subsets of devices. For example, it would be possible to filter devices by any combination of the above attributes. In addition, the management server allows for custom attributes to be added by the operator device 140.

The update campaign is started or deployed at step 270 and the update process begins. The deployment advertises the specified manifest to a list of devices as defined in the device filter. The start of the campaign at step 270 may be triggered by the operator device 140 transmitting to the management server a “start” command. This may, for example, be performed by an API or via a portal. The process of advertising manifests to devices then begins.

At step 280, the progress of the update campaign can be monitored at the operator device 140 by receiving or retrieving progress or status information from the management server 120. During deployment, an advertisement message is sent to a set of devices as defined in the device list.

However, as mentioned previously the deployment may not result in each of the set of devices being updated. For example, devices may or may not see the advertisement, devices may ignore the advertisement for various reasons (such as the devices being low power or being in a critical state), or devices may receive advertisements from other deployments or via other means.

Therefore, the update mechanism described herein provides a mechanism to monitor devices rather than campaigns. For convenience, campaigns can be filtered by the devices they target.

### Manifest Creation

FIG. 3 illustrates an example method by which step 230 can be performed. At step 310, a manifest tool running at the operator device 140 fetches and hashes a payload stored at the management server 120. The payload is loaded from a local file if available, otherwise from a provided URI. At step 320, the tool fetches and fingerprints a certificate (either from the provided URI or the local file). At step 330, the tool creates an inner part of the manifest. The inner part of the manifest may comprise one or more elements of metadata, such as:
provided IDs;
a URI at which the payload is stored;
the payload size; and
the payload hash.

At step 330 of the method, the inner part of the manifest is hashed and then signed at step 340 using the hash and the certificate private key. At step 360, the inner part, hash, signature, certificate fingerprint, and certificate URI is wrapped in the outer part of the manifest.

In some arrangements it may be possible to create a manifest with an encryption mode (for example none-ecc-secp256r1-sha256). To create a manifest with encryption mode, additional information is provided. For example, the following information may be provided:
the type of hashing, signing, and encryption to use (calculated from mandatory inputs if absent);
vendor ID (extracted from defaults if absent);
class ID (extracted from defaults if absent);
payload file (can be overwritten in command line);
description (defaults to empty); and
certificate used for signing (extracted from defaults if absent).

Set out below is an example manifest in which all fields are provided via an input file:

{

“encryptionMode” : “none-ecc-secp256r1-sha256”,
“vendorId” : “<hex representation of the 128-bit RFC4122 GUID that represents the vendor>”,
“classId” : “<hex representation of the 128-bit RFC4122 GUID that represents the device

class>”,

“payloadUri” : “http://path.to/payload.bin”,
“payloadFile” : “/path/to/payload.bin”,
“description” : “Description of the update”,
“certificates”: [

{ “uri”: “http://path.to/certificate.der”, “file” : “/path/to/certificate.der” }

]

}

As mentioned previously, there are a number of different ways data may be provided to a manifest tool. The tool may parse a JSON input file, which can contain all of the information used to create the manifest. Where information is missing from the input file, the manifest tool may check for a file that contains defaults in the current working directory. Another way is to provide data via command line arguments; many of the fields used by the manifest tool can be overidden on the command line.

Manifests may use SHA256 for hashes, ECDSA signatures on the secp256r1 curve, with no encryption. This encryption mode can be referred to as none-ecc-secp256r1-sha256 in the manifest tool.

For creating a manifest with unencrypted payload, the following fields may be used:
a cryptographic mode to use (such as none-ecc-secp256r1-sha256);
payload URI;
the URI of a certificate to be used for signing the manifest or a local file that is a certificate to be used for signing the manifest;
a local file that is the signing key for that certificate; and
the vendor ID and device class ID, or the device ID.

Further payload information that may be stored in the manifest may include:
manifestVersion—the version of the manifest format being used.
description—a free-text description of the update.
vendorld—a RFC4122 UUID, identifying the vendor of the target device or software module in a modular system. If supplied, the target may match this identifier.
classId—A RFC4122 UUID, identifying the kind, model, or version of device or software module. If supplied, the target may match this identifier.
deviceId—A RFC4122 UUID, uniquely identifying the target device. If supplied, the target may match this identifier.
timestamp—The creation timestamp of the manifest. This is used to provide rollback protection. Only the root manifest for a given tree uses this field for rollback protection.
   This value increases and a device may not install a payload with a version older or equal than its current version.
   In case a rollback to an older payload version is required for stability purposes, a new update manifest will be created for the old payload.
nonce—A 128-bit random field. This is provided by the manifest tool to ensure that the signing algorithm is safe from timing side-channel attacks.
vendorInfo—vendor-specific information, which may cause the end-device to not apply this update. This is for extensions specific to narrow circumstances (e.g. a door vendor might have a flag for “don't apply this update unless you're currently locked”).
applyImmediately—this flag indicates that the update described by the manifest should be applied as soon as possible. If not set, this update is not applied unless depended on by another manifest being applied.
validFrom and validTo—times between which it is acceptable to apply this update. Outside of these times, this manifest is not applied.
dependencies—references other manifests (other data types are an error). The update described by this manifest is applied atomically along with all the referenced manifests in this list.
payload—describes an actual payload to be applied. See below for sub-properties:
aliases—Allows a manifest to provide an alternate location for obtaining ann payload referenced in another manifest
encryptionMode—this describes the encryption configuration used to encrypt the payload
initVector—Initialization vector for the AES engine. The size is decided by the encryptionMode. If AES encryption is specified, this field is mandatory.

### Security Mechanisms

The authenticity of an update is to be provable, with sufficient levels of entropy to remain secure for the lifetime of the device (for example, at least 128 bits of security for a 15+ year lifetime). Typically, this means that updates are signed. Other proof mechanisms are acceptable, such as MACs, or Zero Knowledge Proofs. Since the manifest contains information about how to install the update, the manifest's authenticity can be provable. To reduce the overhead required for validation, the manifest contains the digest of the payload, rather than another signature. This does not change the provability of the payload. The authenticity of the manifest is provable with a signature, the authenticity of the payload digest is provable with the manifest, and the authenticity of the payload is provable with the payload digest.

In some arrangements, the manifest is signed by an authorized update author. The update author is the actor that assembled the update image. An intermediary signer may not be used. In such arrangements, the target device has public keys that it uses to authenticate an update provisioned in a secure and irrevocable way. The device does not accept new keys unless they are signed by the old key. The device should retain this audit trail.

Devices regularly expire author public keys and revoke author public keys when an author becomes untrusted. This may be done with certificate expiry and certificate revocation. The server may use a mechanism similar to OCSP stapling to simplify manifest signature certification revocations checks for the device. The management server 120 may be configured to fetch certificates on behalf of the remote device 110 and attach the individual revocation statuses for the certificates involved in verifying the validity to the manifest.

The update author can use an HSM for signing. The content of the manifest can be compared before and after signing. The comparison can be done on a different machine than the signing. For large deployments, the manifest can be verified on an air-gapped computer with an HSM.

For large deployments, the update author can use an air-gapped build machine running a secured compiler. Optionally, the compiler can be signed by the vendor. For large deployments, the compiler itself can sign all build outputs. The digest of the resultant binary should be compared to the digest in the manifest. The update author can verify the contents of the manifest as retrieved from the cloud service prior to dispatching the manifest to a target device._The manifest can contain a digest of the payload.

Manifests can contain a globally, monotonically increasing sequence number. Even when many authorized firmware authors are present, across many locations, the sequence number provided in the manifest can be monotonically increasing.

Manifests and the contents thereof are be stored or transmitted in non-canonical form. If such a mechanism is technically necessary, e.g. a database, then the manifest are transmitted to and verified by the recipient of the non-canonical data. Protection of payload encryption keys. A device vendor can perform a risk analysis and choose their desired level of payload security.

Encrypted payloads can come in a variety of security levels:
Class 0 payloads: unencrypted. The payload is known to be publicly accessible.
Class 1 payloads: encrypted with a permanent pre-shared key, optionally with a key derivation function. The risk presented by the exposure of the payload contents is low. A compromise of one key compromises all future payloads.
Class 2 payloads: A separate pre-shared key is configured for every device, optionally with a key derivation function. Payload delivery to any individual device can be revoked.
Class 3 payloads: Devices use public-key-based key agreement, ensuring that each device receives the same payload decryption key, encrypted using a device-specific key. The private key for key distribution is created for each deployment. Payload delivery to any individual device can be revoked.
Class 4 payloads: Each device receives an individually negotiated random number via an independent, secure channel, then uses this random number in public-key-based key agreement. It then decrypts the payload encryption key using this key. This constitutes Forward Secrecy.
Class 5 payloads: Each device receives an individually negotiated random number via an independent, secure channel, then uses this random number in public-key-based key agreement. The payload is encrypted with this key. This is not broadcast-friendly.

A device vendor chooses which of these payload security classes best fits their risk profile, while balancing the use of symmetric keys (pre-shared, low energy, but hard to protect), asymmetric keys (not shared, high energy, easier to protect), energy profile, etc. When encrypted payloads are used, the manifest can include the digest of the payload encryption key. Any firmware update that is stored off-chip can be signed with a unique, per-device encryption key. Any firmware update that is stored off-chip can be encrypted with an unique, per-device encryption key. Devices can encrypt any off-chip data with an unique, per-device encryption key to prevent extraction. Devices can disable any SWD/JTAG read-out facilities by burning the appropriate debug protection fuses. Where a device supports a secure debugger, this need not be disabled. Devices can check certificate expiry times against manifest timestamps. A manifest may not be accepted if its timestamp is later than the expiry time of the certificate used to sign it. A manifest may not be accepted if its installation time is later than the expiry time of the certificate used to sign it. Devices may enforce time securely using a logical clock, based on secure origins. This applies regardless of whether there is an RTC or not, since RTCs can be attacked as well.

Manifests may be delivered to devices over a secure, authenticated channel. Payloads may be delivered over a secure, authenticated channel. The risk of not delivering manifests, payloads over a secure, authenticated channel is an increased risk of denial of service via the threats mitigated by this requirement. Each device may have an unique, cryptographically provable identity. This identity may be verifiable by a communication partner, such as a server, a peer device, or a user's application. The target device may implement rate limiting that is suitable to its application space. It may not be possible to send many manifests quickly, since that can cause the device to use large quantities of energy and/or flash cycles.

Status reports should be routed through a trusted, private communication medium, which prevents an attacker from inspecting packets sent by a device and selecting which ones to block.

All descriptive information about the payload can be signed. This can include:
The payload location
The payload digest
The payload size
The payload type
All instructions or parameters for applying the payload
Any rules that identify whether or not the payload can be used on this device

In systems with more than one storage location, the update authors may be identified by Access Control List (ACL). These ACLs identify what the update author is permitted to do on a device. For an update to be installed, it may need to meet the required privileges for the target storage location. The privileges are granted by the signature of an Update Author. All actors who receive a manifest validate the authenticity of a manifest before processing its contents.

A trust anchor may be considered to be a public key, installed on a device at time of manufacture that a device trusts completely for a particular task. Trust anchors should not be replaced, revoked, or expired. A trust delegate may be considered to be a public key, signed by a trust anchor, or a trust delegate. Ultimately, each chain of delegation ends in a trust anchor. Trust delegates may be replaced, revoked, or expired at any time.

A security model that can be applied to the systems described herein is built using the security requirements discussed above.
1. Trust
   i. At manufacturing time, each device is securely provisioned with one or more public keys that it trusts for update. These are referred to as trust anchors. Each update can be verifiable with a trust anchor, or a trust delegate. A trust delegate is a public key which has been signed by the trust anchor's private key.
   ii. Trust delegates may delegate further.
   iii. Delegation of trust can provide a mechanism for restricting the privileges of Trust Delegates
   iv. Trust delegates can have expiration dates.
   v. Only the trust anchor, or a trust delegate closer to the trust anchor may revoke a trust delegate.
   vi. If a trust anchor or trust delegate is stored off-chip, then it is encrypted and signed.
2. Manifests
   i. A block of metadata, called a manifest is used to describe the update.
   ii. The manifest is signed by the update author. Cloud signing may be prohibited.
   iii. The manifest may be signed on the update author's computer or on the update author's HSM. The update author compares the pre- and post-signing content of the manifest.
   iv. The manifest may be signed using an industry-standard container format, CMS, also known as PKCS-7, or RFC5652.
   v. By using CMS, (PKCS-7/RFC5652), the manifest can be signed by standard PKCS-11 compatible HSMs or smart cards. This can also be done on an air-gapped HSM.
   vi. The manifest may be signed by one or more trust anchors or trust delegates.
   vii. The manifest may therefore contain:
      a. a digest, that may be at least SHA-256 in strength, of the payload;
      b. a UTC timestamp, in seconds;
      c. The payload location;
      d. The payload digest;
      e. The payload size;
      f. The payload type;
      g. All instructions or parameters for applying the payload;
      h. Any rules that identify whether or not the payload can be used on this
      i. If the payload is encrypted, the manifest contains the digest of the payload key.
3. Payload
   i. The payload may be encrypted using several models. When encrypted, the manifest contains the information that the device requires to decrypt the payload, but not sufficient information that any other party can decrypt it.
   ii. Once downloaded, the payload is signed by the update client and stored either:
      a. on-chip; or
      b. off-chip, encrypted (for example with AES-128 or better) and/or signed with at least 128 bits of security.
4. Services
   i. Update authors may upload an update certificate to their service account to permit service-side validation of manifest signatures.
   ii. Upon receipt of a manifest the update service:
      a. validates the signature of the manifest. If no corresponding certificate is available, the update service reports an error.
      b. validates all generic manifest fields. Note that some fields are not verifiable without knowledge available only to the device.
   iii. Update authors may opt-out of service-side validation of manifests, but this may not be a default position.
   iv. A device administrator may inspect human-readable portions of the manifests before authorising deployment of an update to devices. This may be done without adding a signature.
   v. An update service ensures that data presented to users is correct.
      a. The user uploads the public key used for validating manifests to the update service.
      b. When receiving a manifest, the update service validates its signature.
      c. When extracting a manifest in response to a search, the update service validates its signature, then compares the manifest contents to the search terms.
      d. The update service delivers the canonical manifest via any APIs.
      e. The SDK and the web portal both validate the manifest signature locally, then parse the manifest into the required data format.
      f. The SDK and the web Portal both provide a “final check” mechanism that displays the contents of the manifest, parsed locally, for the user to check. These contents are compared against any other fields previously displayed to the user and any discrepancies are highlighted.
   vi. The update service delivers the manifest to the target device over TLS or DTLS.
   vii. The update service accepts status reports only over TLS or DTLS.
   viii. The update service takes appropriate steps to ensure that it only allows modern TLS/DTLS connections.
   ix. The update service ensures that only unique devices connect to the services.
   x. The update service verifies each device's identity cryptographically.
5. Devices
   i. The device have a unique private key.
   ii. After each manifest is received, regardless of update success, the device enters a cooling-off period where it will reject all manifests with a “Rate Limit” error iii. When a device receives the manifest, it:
      a. verifies the manifest signature.
      b. Checks that the timestamp of the manifest is not later than the expiry of the certificate.
      c. Checks that the installation time of the manifest is not later than the expiry of the certificate.
      d. Verifies all manifest fields

### Manifest Upload

FIG. 4 illustrates an example workflow for creating and uploading a manifest to the management server 120. As can be seen from FIG. 4, there are a number of different elements that are illustrated in this example. As mentioned previously, the management server 120 is configured to provide an asset update service which comprises a service for storing and maintaining firmware payloads, for example in the form of firmware images. The service may be handled in a firmware catalogue service, as shown in FIG. 4. Moreover, the storage of manifest data is provided in a manifest storage. The management server 120 either directly stores or remote manages the storage of the manifests in the manifest storage. The management server 120 also provides an API gateway and a portal through which manifests can be uploaded from the developer device. The developer device may be configured to operate an update tool that is configured to handle the creation of a manifest and a signing tool that is configured to sign the manifest before it is uploaded to the management server 120.

The workflow of FIG. 4 begins at step 401 at which a request to generate a manifest is created at the developer device and passed to the update tool. At step 402, the manifest is created and passed to the developer device. At step 403, the unsigned manifest is passed to the signing tool along with a signing key at step 404. The manifest is signed using the signing key and returned to the developer device at step 405. At step 406, a request is made by the developer device to upload the signed firmware manifest to the management server 120. This request is made via the portal at step 406 and the API gateway at step 407. At step 408, the request to upload the signed manifest is passed to the firmware catalogue which checks at step 409 if the size of the manifest exceeds pre-determined limits and parses the manifest fields. At step 410, the manifest is transmitted to the manifest storage to be stored. At steps 411 to 416, a confirmatory message is returned through the elements to confirm that the manifest has been successfully stored in the manifest storage.

### Payload Upload

FIG. 5 illustrates an example workflow 500 for creating and uploading a payload of an asset to be updated to the management server 120.

As can be seen from FIG. 5, there are a number of elements in the workflow. In this example, the management server 120 is also configured to provide a service for storing and maintaining asset payloads, for example in the form of firmware images. The service may be handled in a firmware catalogue service, as shown in FIG. 5. Furthermore, the management server 120 either directly stores or remotely manages the storage of the firmware payloads in a firmware storage. The management server 120 also provides an API gateway and a portal through which a firmware image can be uploaded. In addition, the developer device also has access to build tools which can be used to build the firmware image.

The workflow begins at step 501 at which a request to build a firmware image is transmitted to the build tools from the developer device. The build tools return at step 502 a compiled image to the developer device. At step 503, a request to upload the firmware is passed via the portal at 503 and the API gateway a step 504 to the firmware catalogue service at step 505 in the management server 120. At step 506, the firmware image is stored in the firmware storage. At steps 507, 508, 509, and 510 confirmatory messages confirming that the firmware has been stored are returned to the developer device.

### Campaign Creation

FIG. 6 illustrates an example workflow 600 for creating a campaign and providing the campaign to the management server 120. As can be seen from FIG. 6, there are a number of elements in the workflow. In this example, the management server 102 enables an update service to be provided. This update service can be considered to be implemented as a software module within the management server 120. To illustrate the workflow the software module can be separated into a number of sub-modules or sub-services. In this example, the portal is a web portal provided by the management server 120 that provides an interface through which the operator device 140 can interact or interface with the management server 120.

Also provided is an API gateway through which communications are passed into the sub-services of the management server 120. In the example of FIG. 6, there are a number of different sub-services that are operated by the management server 120. In practice, the operation of the management server 120 may be considered at a higher level of abstraction such that it is a single service. However, for the purposes of illustrating the workflow of data, in this example three sub-services are illustrated—namely a firmware catalogue service that manages the storage and maintenance of received firmware payloads, a device catalogue service that manages the storage and maintenance of device filters, and a deployment service which manages the deployment of the created campaign.

The workflow of FIG. 6 begins at step 601 at which the operator device requests the creation of a new campaign. At step 602, in response to the request to create a new campaign, a request is issued to the API gateway through the portal for a list of available manifests which is accessible via the firmware catalogue service. The API gateway forwards, at step 603, the request to obtain a list of available manifests to the deployment service. At step 604, a manifest list indicating the list of available manifests is transmitted from the firmware catalogue service to the API gateway. The manifest list is transmitted at step 605 from the API and presented to the operator device via the portal. At step 606, the device operator selects a particular manifest from the list of available manifests to be associated with the campaign and begins the process of generating a campaign based upon the selected manifest.

At step 607, a create campaign message is transmitted from the cloud portal to the API gateway, the create campaign message comprises an indication of the manifest that is to be associated with the selected manifest. At step 608, the API gateway forwards the create campaign message to the deployment service which records the creation of a campaign associated with the selected manifest. At steps 609 and 610, confirmation messages that the campaign has been created at the deployment service are transmitted.

At step 611, the portal issues a request to the API gateway for a list of valid device filters. The valid filters can, for example, be selected from the filters which specify a device manufacturer and model number listed in the selected manifest. Other fields in the manifest can additionally or alternatively be used to identify the list of valid device filters to be used based upon the manifest. A request for the list of valid is transmitted from API gateway to the device catalogue service at step 612. The device catalogue determines which of the filters made available at the device catalogue service are valid and returns a valid list at step 613 to the API gateway, which is then forwarded at step 614 to the portal. At step 615, the device filter to be used is selected from the list of valid device filters and provided to the portal. The portal transmits a campaign update message to the deployment service via the API gateway at steps 616 and 617. The campaign update message indicates the device filter to be used. Once received at the deployment service, the campaign is updated at the deployment service. Confirmation messages confirming that the update has taken place are returned to the portal and presented to the operator device at steps 618 and 619.

At step 620, the operator device initiates at step 620 the start of the update campaign by entering data the web portal. For example, this may take the form of a start campaign message or an interaction with a user interface. At steps 621 and 622, the start campaign message is transmitted from the web portal, through the API gateway, and to the deployment service. The deployment service may immediately initiate the update campaign if there is bandwidth to do so. Alternatively, if other campaigns are currently in progress the deployment service may be queued for processing once resources are available. At steps 623, 624, and 625 a confirmation is returned to the operator device that the update campaign has been initiated. By providing this approach, it is not necessary for the device operator to receive a copy of the payload in order to generate a campaign.

In some arrangements, the created campaign data may be signed before it is uploaded to the management server 120. In such approaches, the signed campaign data may be required by the remote device 110 which is to be updated in order to authenticate the campaign data, and accept it. The campaign data may be signed using a public key cryptographic signature or a keyed-hash message authentication code (HMAC). The signing of the campaign data achieves end-to-end security of the campaign data which protects against altered maliciously.

The remote device 110 may be configured to act to resolve any conflict between received campaign data and received manifest data. For example, the remote device may receive manifest data indicating that devices belonging to a particular manufacturer are to be updated but may receive campaign data that allows another manufacturer (for example the campaign data may make an exception to the valid manifest data). The remote device 110 may automatically reconcile the conflict, for example by automatically deferring to one of the campaign data and the manifest data based on a pre-determined rule. Alternatively, the remote device 110 may notify the management server 120 of the conflict that must be resolved by user intervention.

### Campaign Processing

FIG. 7 illustrates an example workflow 700 within the management server 120 for initiating an update campaign by processing campaign data in response to a request to start a campaign and discussed with relation to FIG. 6. As mentioned previously, the example of FIG. 7 illustrates a number of different sub-services provided by the management server 120. In some implementations, the management server 120 may operate as a single service. However, for the purposes of illustration the processing of a campaign will be illustrated in relation to a sub-services approach.

The workflow of FIG. 7 begins at step 701 at which the deployment service retrieves information concerning the next queued campaign to be processed. Based on the retrieved campaign information at step 702 the deployment service performs a filter of the devices to which the update campaign is to be applied based on the device filter of the campaign data and retrieves from the device catalogue service a list of devices to which the update is to apply.

At step 703, campaign metadata entries are created for the device and at step 704 the deployment service provides data to the device catalogue service such that a device log for a remote device can be updated at step 705 to reflect the deployment of updated asset data to the remote device.

At step 706, a request for manifest data is sent from the deployment service to the firmware catalogue and at step 707 the firmware catalogue returns a copy of the manifest. An updated manifest data is sent to the connector channel service at step 708 which transmits manifest data to one or more remote devices in accordance with the device filter. The devices either acknowledge receipt of the communication or do not, based on the success of the communication. The resultant status of the update is returned at step 710 to the deployment service which updates the metadata associated with the remote device at step 711.

### Campaign Monitoring

FIG. 8 illustrates an example workflow for monitoring the progress of a campaign. As with the above-described figures, the management server in this example comprises a plurality of sub-services, including a device catalogue service, a connector channel service and a deployment service. Moreover, an operator device is able to communicate with the management server 120 via a portal and an API gateway.

Workflow 800 begins at step 801 where the connector channel service is notified of a change in the resource of a device. This may occur, for example, using an HTTP callback. At step 802 the connector channel service informs the device catalogue service of the resource change. At step 803, the device catalogue service creates a device log entry relating to the resource change. At step 804, the connector channel service informs the deployment service if all the devices have reached the target version, at which point the campaign can be marked as complete.

At any point, the operator device initiates at step 805 an instruction via the portal to monitor the campaign. At steps 806 and 807, the portal requests device log entries for the campaign which are retrieved from the device catalogue service at step 807 and returned to the API gateway at step 808. The logs can then be provided to the operator device to show to the operator device the status of the update of the asset of the remote devices according to the update campaign.

### Multiple Service Requestors

FIG. 9 illustrates a computing system 900 comprising a management server 120, a developer 130, and a device operator 140, and a plurality of remote devices 110. These elements correspond to like elements in FIG. 1.

In the arrangement of FIG. 9, the remote devices 110, developer device 130, and device operator 140 or all linked in that they all relate to a first service requestor. A service requestor can be considered to be an associated organisation or users having a common level of access to the permitted remote devices. For example, the developer 130 develops firmware for remote devices 110 that form part of a first service requested by the first service requestor. As such the payload and manifest generated by the developer 130 of the first service requestor can be accessed by the device operator 140 of the first service requestor.

The management server 120 can be configured to manage multiple update services in parallel, each requested by a separate service requestor. For example, in the arrangement of FIG. 9, three update services are being requested in parallel. A first update service is being requested by a first service requestor in the form of a developer 130, device operator 140, and remote devices 110 (the first service is illustrated by devices with a clear background). A second update service is being requested by a second service requestor in the form of a developer device 131, operator device 141, and remote devices 111 (illustrated by a lightly dotted background). A third update service is being requested by a third service requestor in the form of a developer device 132, an operator 142, and remote devices 112 (illustrated by a more heavily dotted background).

For a particular service requestor, the device operator for that service has access to the payload data and manifest data provided to the management server 120 from the developer device of that service provider. However, a particular service requestor would not necessarily have access to the payload data and manifest data of another service requestor. Similarly, a subset of the remote devices communicatively coupled to the management server would typically be associated with a particular service requestor. Such remote devices can be therefore be referenced and updated using a campaign associated with that same service requestor. However, unless explicitly allowed for by the service requestor, a service requestor will not be able to access or update remote devices that do not belong to the service requestor.

In the example of FIG. 9, a first service requestor may control an update of at least some of the remote devices 110 using the device operator 140 and the developer device 130. However, the first service requestor may be prevented from updating devices 111 and 112 since the devices are to be updated by second and third service requestors. By providing this capability, a single management server is able to operate multiple update campaigns from different parties using the same interfaces. This results in a unified and standardised approach to updating firmware that can be applied to a multitude of devices in different physical locations in a secure manner.

As will be appreciated by the skilled person, the communication between the various elements of the system can be performed by a wired connection or a wireless connection. For example, the mechanisms described herein may be performed in a manner that is agnostic to the update method and to the communication method between devices and servers. For example, the mechanisms described herein are application to updates via USB mass storage (CMSIS-DAP), server APIs, UART, ZigBee, BLE, Ethernet (TFTP+DHCP) and WIFI are covered by the same format. Moreover, communication between devices and servers may occur via any wired or wireless communication. The communications between various devices may be direct or indirect, and thus may occur through one or more gateways, and may occur over one or more different communication protocols or physical transmission media provided that a communicative channel between devices is established.

As will also be appreciated, reference herein to a device or a server should not be interpreted to be limited to a single hardware element. The techniques described herein are applicable to cloud computing techniques in which the operation of a single device or server, or the provision of a single service, may be distributed amongst one or more physical devices or servers. Accordingly, reference herein to a server should include reference to a plurality of servers that are communicatively coupled so as to provide the functionality of the single referred-to server.

In a particular aspect, present techniques provide a method for managing an asset update service for one or more service requesters on a plurality of remote devices, the method comprising: receiving, at a management server, update data indicating an asset to be updated at one or more remote devices; receiving, at the management server, campaign data associated with the update data and indicating a subset of the remote devices to which an update is to be applied; and receiving, at the management server, a request to initiate an asset update by transmitting to the subset of the remote devices an update communication indicating that the asset is to be retrieved for updating the asset of the remote device.

In a further particular aspect, present techniques provide a management server for managing an asset update service for one or more service requesters on a plurality of remote devices, the management server comprising: at least one interface to: receive, at the management server, update data indicating an asset to be updated at one or more remote devices; receive, at the management server, campaign data associated with the update data and indicating a subset of the remote devices to which an update is to be applied; and receive, at the management server, a request to initiate the asset update by transmitting to the subset of the remote devices an update communication indicating that the asset is to be retrieved for updating the asset of the remote device.

The methods described herein can be implemented in hardware or software or any combination of hardware and software. For example, the methods described herein can be implemented as computer-readable code comprising computer-readable instructions. The computer-readable instructions may be stored on a computer-readable storage medium, including a non-transitory computer-readable storage medium, such as a hard-disk or solid-state memory.

1. A method for enabling an asset update for one or more service requesters on a plurality of remote devices, the method comprising:
receiving, at a management server, update data indicating an asset to be updated at one or more remote devices for a first service requester, the update data comprising manifest data comprising a payload uniform resource identifier (URI) indicating where the payload is stored, authentication information indicating the trust of the manifest data, and a payload hash;
receiving, at the management server, campaign data associated with the update data and indicating at least a subset of the remote devices to which an asset update is to be applied for the first service requester; and
receiving, at the management server, a request to initiate the asset update for the first service requester by transmitting to the at least the subset of the remote devices indicated by the campaign data an update communication comprising the manifest data indicating that a payload is to be retrieved for updating the remote device.

2. The method according to claim 1, wherein the asset comprises firmware of the remote device.

3. The method according to claim 2, wherein the update data comprises:
payload data comprising firmware data of a firmware update to be applied to one or more remote devices; and
manifest data comprising metadata relating to the installation of the payload data.

4. The method according to claim 3, wherein the campaign data is associated with the manifest data and wherein the update communication comprises manifest data for the payload to be applied.

5. The method according to claim 1, wherein the campaign data comprises a device filter indicating a filter to apply to identify remote devices to which the update is to be applied.

6. The method according to claim 5, wherein each remote device has associated therewith one or more fields identifying information relating to the device, and wherein the device filter comprises values for one or more the fields that are used to identify which of the remote devices are to be updated according to the campaign data.

7. The method according to claim 1, wherein the update data and the campaign data are received via an application programming interface (API).

8. The method according to claim 1, wherein the management server is further configured to receive update status information from the subset of remote devices indicating the status of the firmware update at the remote device.

9. The method according to claim 1, wherein the update data is received from a developer device and the campaign data is received from an operator device, and wherein the developer device and the operator device are associated with the first service requester.

10. The method according to claim 1, further comprising:
receiving, at the management server, second update data indicating second firmware to be updated at one or more remote devices;
receiving, at the management server, second campaign data associated with the second update data and indicating a second subset of the remote devices to which an update is to be applied, wherein the second subset is different to the first subset; and
receiving a request to initiate the second firmware update by transmitting to the second subset of the remote devices a second update communication indicating that the second firmware is to be retrieved for updating the firmware of the remote device.

11. The method according to claim 10, wherein the second update data comprises:
second payload data comprising second firmware data of a second firmware update to be applied to one or more remote devices; and
second manifest data comprising second metadata relating to the second payload data.

12. The method according to claim 11, wherein the second campaign data is associated with the second manifest data and wherein the second update communication comprises second manifest data for the second payload to be applied.

13. The method according to claim 10, wherein the second campaign data comprises a second device filter indicating a second filter to apply to identify remote devices to which the second update is to be applied.

14. The method according to claim 13, wherein each remote device has associated therewith one or more fields identifying information relating to the device, and wherein the second device filter comprises values for one or more the fields that are used to identify which of the remote devices are to be updated according to the second campaign data.

15. The method according to claim 10, wherein the second update data and the second campaign data are received via an application programming interface (API).

16. The method according to claim 10, wherein the management server is further configured to receive second update status information from the second subset of remote devices indicating the status of the second firmware update at the remote device.

17. The method according to claim 10, wherein the second update data is received from a second developer device and the second campaign data is received from a second operator device, and wherein the second developer device and the second operator device are associated with a second service requester.

18. The method according to claim 1, further comprising, in response to a request to initiate the firmware update, transmitting to the subset of the remote devices an update communication indicating that the firmware is to be retrieved for updating the firmware of the remote device.

19. The method according to claim 3, further comprising:
receiving a manifest request for a list of manifests stored at the management server;
returning, in response to the manifest request, the list of manifests stored at the management server;
receiving a device filter request for a list of device filters stored at the management server;
returning, in response to the device filter request, a list of valid device filters determined from the device filters stored at the management server.

20. A method according to claim 19, wherein the device filter request identifies a manifest, and wherein the method further comprises:
determining the list of valid device filters from the device filters stored at the management server by selecting a subset of stored device filters based upon device filters that meet one or more fields defined in the identified manifest.

21. A method according to claim 19, wherein the device filter request identifies a manifest, and wherein the method further comprises:
determining the list of valid device filters from the device filters stored at the management server by selecting a subset of stored device filters based upon device filters that meet at least one of a device manufacturer and model number listed in the identified manifest.

22. A method according to claim 1, wherein the management server stores one or more campaigns according to the campaign data.

23. A method according to claim 1, wherein the received campaign data is signed before being received at the management server.

24. A method according to claim 23, wherein the campaign data is signed using a public key cryptographic signature or a keyed-hash message authentication code (HMAC).

25. A method according to claim 22, wherein the campaign data is forwarded to the subset of the remote devices for authentication.

26. A management server for enabling an asset update for one or more service requesters on a plurality of remote devices, the management server comprising:
at least one interface to:
receive, at the management server, update data indicating an asset to be updated at one or more remote devices for a first service requester, the update data comprising manifest data comprising a payload uniform resource identifier (URI) indicating where the payload is stored, authentication information indicating the trust of the manifest data, and a payload hash;
receive, at the management server, campaign data associated with the update data and indicating at least a subset of the remote devices to which an update is to be applied for the first service requester; and
receive, at the management server, a request to initiate the asset update for the first service requester by transmitting to the at least the subset of the remote devices indicated by the campaign data an update communication comprising the manifest data indicating that a payload is to be retrieved for updating the remote device.

27. An apparatus to perform the method of claim 1.

28. A non-transitory, computer-readable storage medium configured to store code comprising computer-readable instructions which, when executed by a processor, cause the processor to perform the method of claim 1.

29. (canceled)
